(19) United States
(12) Patent Application Publication
(10) Pub. No.: US 2024/0282472 A1
(43) Pub. Date: Aug. 22, 2024

(54) Method For Estimating A Future Value Of A Physical Quantity Of An Industrial System Such As A Nuclear Reactor

(71) Applicant: Electricite de France, Paris (FR)

(72) Inventors: Patrick Bodet, Antony (FR); Franck Delcoigne, Paris (FR); Serge Marguet, L'hay Les Roses (FR); Thomas Penit, Gif Sur Yvette (FR)

(73) Assignee: Electricite de France, Paris (FR)

(21) Appl. No.: 18/380,899

(22) Filed: Oct. 17, 2023

(30) Foreign Application Priority Data
Oct. 18, 2022 (FR) 2210720

(51) Int. Cl. G21C 17/02; G01M 99/00

(52) U.S. Cl. CPC G21C 17/02; G01M 99/005

(57) ABSTRACT

A method for estimating a quantity of a system includes the following steps:
for each variable of a plurality of variables, obtaining a sequence of successive measurements,
determining a sequence of successive values of a stability parameter, the parameter being a weighted sum of rates of variation of the variables,
identifying a time interval in which the stability parameter is less than or equal to a predetermined threshold for a duration greater than or equal to a predetermined duration,
estimating a sequence of successive estimates of a particular variable, a start time of the sequence being included in the time interval,
comparing the sequence of estimates and the sequence of measurements, in order to determine an adjustment parameter, and
estimating the physical quantity of the system using the adjustment parameter.

### CROSS-REFERENCE TO RELATED APPLICATIONS

This application claims priority from French application number 2210720, filed Oct. 18, 2022, the disclosure of which is hereby incorporated herein by reference.

### FIELD OF THE INVENTION

The invention relates to the estimating of a future state of a complex industrial system and in particular of a nuclear power plant and of a nuclear reactor.

### PRIOR ART

Here, a complex industrial system shall mean a system, the state of which depends on many physical quantities and the evolution of which depends very sensitively on its initial conditions. Measurement or knowledge of many variables is required in order to characterise such a system. The evolution of such a system also depends on many variables, the evolution of which variables can depend on one another.

Industrial systems are difficult to control, in the sense that in order to take them from one operating point to another, the system can become highly unstable such that it is very difficult to predict its evolution.

A nuclear reactor constitutes an example of a complex industrial system. The physical phenomena which are produced therein, relate to nuclear physics and, in particular, neutronics, thermodynamics and, in particular, thermohydraulics and thermomechanics. In a reactor, it is the population of neutrons which governs the primary energy generation, which energy is communicated to a heat-transfer fluid according to various transfer mechanisms. This population and its spatial distribution varies over time depending on its interaction with the surrounding matter comprising, in particular, the fuel and the heat-transfer fluid. This variation is, in particular, a function of the absorption (fissile, fertile and sterile), diffusion, reflection and leaks of neutrons. It should be noted that a variation in population can cause the properties of the surrounding matter to vary, which variations can then feedback on the neutron population.

For example, a nuclear fission following an interaction between a heavy nucleus and a neutron produces an energy which can be absorbed by the heat-transfer fluid. The temperature of the surrounding medium is modified and this variation in temperature in turn modifies the nuclear reactivity in the reactor such as, in particular, the probability of absorption of a free neutron by a heavy nucleus. The phenomena called into play in the reactor are diverse in nature and they interact with one another. In addition, it should be noted that the population of neutrons depends on the kinetics of the processes for neutron production by fission distributed between prompt neutrons and delayed neutrons; the latter being in the minority and emerging several seconds after the prompt neutrons being essential for control of the reactor.

In the case of nuclear reactors, there is a growing need for manoeuvrability linked to the emergence of so-called renewable energies. Systems producing so-called renewable energies have an increasing presence on the electrical grid. By nature, these are linked to the climatic conditions and therefore produce intermittent and fluctuating electrical power. The electricity grid cannot function correctly if it also exhibits such fluctuations. The production of electricity by nuclear plants can be controlled, unlike the production by systems producing so-called renewable energies. Nuclear plants can therefore be used to supplement renewable energy systems, in order to ensure overall stability of the electricity grid resulting in a balance in electricity production and consumption. In order to further integrate so-called renewable energy on the grid, while adapting it to the demand, it is necessary that the operation of a nuclear reactor is adjusted more frequently, in other words that it can be adjusted over shorter and more numerous time windows than in previous practice.

There is therefore a need to better predict the evolution of a complex industrial system, and, in particular, that of a nuclear reactor.

In order to more precisely introduce the invention and its application to a nuclear reactor, the following additions are specified.

The invention relates, in particular, to the field of the operating of a nuclear reactor of an electricity production plant. More precisely, it is used for neutronic simulation of nuclear cores in operation, in order to enable the operator of a nuclear unit to evaluate the predictable safety margins.

The term “nuclear unit” shall mean an electricity production unit, schematically composed of a nuclear boiler, circuits supplying the power generating turbine, and the control system enabling an operator to control the production of electricity.

Compliance with these margins, which ensures safe operation, is currently guaranteed by the control rules. The simulation tool does not substitute this, but makes it possible, while complying with the control rules, to optimise control and better adapt to the constraints of the electricity grid. In particular, when renewable energies produce electricity on the grid, the simulation tool makes it possible for the nuclear unit to adapt more rapidly, while taking part in an overall approach of reducing CO2 emissions.

More particularly, the field of the present invention relates to the numerical simulation of complex physical phenomena such as those produced during the operating of a nuclear unit.

Furthermore, the control of a nuclear reactor requires the present state of the reactor to be known, in order to be able to attain a predetermined operating point with the help of control means available to the operating operator.

However, said physical phenomena within a nuclear reactor are highly complex which makes it necessary to call upon multiple branches of physics, including nuclear physics, neutronics (e.g. laws which govern the neutron population), thermohydraulics (e.g. fluid mechanics and heat transport), thermodynamics and thermomechanics (the effect of forces on materials subjected to heat); these sciences applying here to the core of nuclear reactors. It can be seen that the phenomena which occur are of diverse nature and they also interact with one another. Hence, and for example, a fission (nuclear physics) is produced by the interaction of a heavy nucleus with neutrons (neutronics), said fission produces heat which propagates in the material (thermodynamics), which transmits its heat to the water which transports it (thermohydraulics). Here, neutronics is the central branch due to the fact that it governs the generation of the above-mentioned phenomena, it enables the characterisation of the spatially and temporally distributed neuron population according to an energy spectrum which will depend on the interaction with the material. These interactions are absorption (fissile, fertile and sterile), diffusion, reflection and leaks of neutrons. To this must be added a kinetic component linked to the effective production of neutrons by fission divided into prompt neutrons and delayed neutrons; the latter being in the minority and emerging several seconds after the prompt neutrons, are essential for controlling the reactor.

Hence, it would appear clear that neutron behaviour cannot be entirely understood in its entirety by an operator of a nuclear unit, who wishes to take a decision on the basis of easily interpretable indicators. Ultimately, the operator has no assessment of the state of stability of a reactor which would enable him to predict, on the basis of the observed state, by neutronic simulation, a path of the operating point which is closest to reality. If the starting state is wrong, then the path of the operating point will be also. This is the more generally known problem referred to as knowledge of the “initial conditions” of a physical system before applying a physical simulation model to it.

It is therefore understood that the development of renewable energies necessarily demands an increased manoeuvrability for nuclear power plants. Responding to network requests requires being able to simulate:
on the one hand quickly, for example in less than two minutes of calculation, for a power transient extending over a range of ten hours, and
on the other hand precisely, the control actions to be undertaken.

Indeed, compliance with the operating and safety margins must always be ensured, and these margins must therefore be precisely anticipated. A precise simulation further enables the operator to refine the control strategy for optimising the operating.

This optimisation can take multiple form, and the action of the operator is fundamental to making the choice that leads to it.

Take, for example, the case of an increase in power by dilution of the borated water present in the core. This dilution reduces the concentration of boron which is a neutron absorber. This lowering of the concentration of boron therefore automatically increases the population of neutrons, thus the number of fissions and hence the power level.

This dilution gives rise to movements of water leading to discharge of borated water, which constitutes an effluent, thus a penalising waste for the plant operator, even if this waste is recoverable.

The operator can act on the boron or the absorbent bars in order to control the power of the reactor. Each means has different features:
the absorber rods have an immediate action on the power of the reactor, but destabilise it axially and create a temporal oscillation which will be compensated with boron (resulting in production of effluent for a second time), and above all a risk of moving out of the operating range if the compensation is not sufficient.
Boron has a homogeneous geometric effect on the power, but it has a more moderate rate of action than the absorber rods, and with a certain delay (the transport of boron from its storage reservoir to the core takes around ten minutes). Each introduction of borated water into the primary circuit which supplies the nuclear core must be compensated by withdrawal of an equivalent volume (because the volume of the circuit is constant), in other words by the production of liquid effluents. By contrast, the axial distribution of power is less disturbed than during the use of absorber rods, which will require less compensation for a second time.

It can therefore be seen that the choice of the control mode requires the reconciliation of two contradictory technical requirements: control of the axial power distribution and production of liquid effluents. The phenomena brought into play are complex, and the use of the simulation tool is therefore fundamental for evaluating the axial imbalance of power and the volume of effluents produced. This knowledge will allow the operator to choose a good compromise, depending on the external constraints (request for rapid power variation, financial or technical constraints relating to the production of effluents).

### Already Known Solutions/Existing Products or Methods

The operator essentially has two main means of action for controlling the nuclear reactor:
absorber rods, the insertion or withdrawal of which enables the power and temperature of the reactor to be modulated,
boron diluted in water absorbing neutrons.

In order to use the available control means wisely, in other words effectively and in compliance with the safety criteria, the operator needs to know the current state of the nuclear unit, and to satisfactorily understand the transient to be passed in order to reach the desired future state.

This is principally the evolution of the xenon in the core which impacts the actions to take. Xenon 135, which is one of the fission products, produced directly or by disintegration of other fission products, is a very important neutronics poison, the production of which is linked to the current state of the nuclear unit but also to its past states, and strongly impacts the future states. Produced and consumed in a neutron flux, xenon thus reaches an equilibrium level linked to the current power. In the case of a reduction in power, the production of xenon continues but not its consumption due to the reduction in the neutron flux, which causes an accumulation of xenon which must be compensated in order to stabilise a new power level. The physics of xenon gives rise to oscillating phenomena, referred to as temporal and spatial xenon oscillations, which, if they are not controlled, can lead to a departure from the acceptable operating range of the nuclear reactor. In practice, this is manifest by an automatic stopping of the core due to non-compliance with safety margins. A precise simulation of the future state of the core is therefore fundamental for controlling a manoeuvring nuclear unit.

Within the reactor, the axial direction z can be defined as the vertical direction given by a plumb line. This direction z is oriented vertically upwards within the reactor. In order to characterise the variation between a power Pₕ in the upper half of the core of the reactor and a power P_{b} in the lower half of the core of the reactor.

In particular, it is used to provide a precise simulation of the axial offset (abbreviated AO) or the axial power imbalance that can be designated by the notations “ΔI” or “DPAX”). These two quantities characterise the variation in power between the top and bottom of the reactor and are defined by the following formulas:

$$\\ A O = \frac{{P}_{h} - {P}_{b}}{{P}_{h} + {P}_{b}}$$

$$\\ D P A X = \frac{{P}_{h} - {P}_{b}}{{P}_{n}}$$

where Pₙ is the nominal power of the reactor.

The term Pₕ+P_{b}=Pₜ designates the total instantaneous power in the reactor. The axial offset is a relative value of power with respect to the total instantaneous power.

The axial imbalance “DPAX” is a relative value of power relative to the nominal power Pₙ, nominal power which is not necessarily equal to the total instantaneous power Pₜ.

The relation between the two quantities is as follows:

$$\\ D P A X = A O \times \frac{{P}_{h} + {P}_{b}}{{P}_{n}} = A O \times {P}_{rel}$$

Where Pᵣₑₗ is the relative power expressed as a percentage of the nominal power.

This simulation can ensure that temperature thresholds which are dangerous for the integrity of the nuclear fuel are not crossed. The axial offset parameter cannot be understood without a simulation tool over periods of several hours by an operator, even if highly experienced.

This simulation is provided by numerical tools (Control Assistance Tools). The control assistance tool is a numerical tool which operates continuously when the nuclear reactor is running. It is supplied in real time with experimental data coming from sensors, and by essential data calculated on the basis of sensor measurements. Its role is to provide the operator with a real-time overview of the state of the core. This state is determined using:
the graphic representation of experimental quantities, associated with their theoretical or calculated limits (for example, position of the group R-absorber rods referred to as control rods-associated with its insertion limit), and
the graphic representation of quantities that are important for the control, but are not measurable. These are therefore obtained by calculation (example: AO Iodine; axial imbalance of the distribution of iodine between the upper half of the core and the lower half of the core).

In the text, the terms “clusters”, “groups”, or “rods”, are used, in the singular or plural, to designate devices for inserting neutron absorbers into the core.

An absorber rod is, as its name indicates, a long pencil of absorbent material. In the core, the rods are grouped into clusters. Each cluster inserts into a fuel assembly. They are grouped into groups of clusters of equivalent neutron-absorbing weight, distributed homogeneously in the core, in order that their insertion does not destabilise the radial distribution of power.

The role of the simulation is also to enable the operator to prepare a power transient. For this, the control assistance tool enables simulations to be performed. The result of these simulations is also presented in graphical form to the user (control diagram, position of groups, boron concentration curve, etc.) to enable the future of the state of the core to be visualised.

The method is iterative: the operator formulates hypotheses (for example, obtaining a state by placing the rods at a given position), visualises their impact, then modifies them and restarts a simulation if necessary, until the requirements in terms of control are fulfilled (for example, minimising the volume of liquid effluent, obtaining stability of the core as soon as possible, ramping up the power more quickly, etc.).

The majority of current control assistance tools use 0D or 1D neutronics codes. For the OD codes, access to the simulation of the AO, axial quantity, is impossible in principle. The assistance provided is therefore limited, and the power transients to be carried out cannot be optimised by simulation.

The 1D codes provide the axial parameters which are of interest for the control, but the modelling of a complex entity such as a nuclear core in the form of a simple “1D thread” is limited on cores of large dimensions. More specifically, in these reactors, since the neutrons have a short mean free path relative to the overall geometry, parts of the core that are far apart from one another will behave in a physically decoupled manner. In order to correctly simulate these “decoupled sectors” of the core, it is necessary to introduce 3D modelling.

Tools equipped with a 3D code currently exist, but most of the time correspond to “core monitoring” assistants, or the accent is placed on visualisation of the current state of the unit, but not on simulation of the future. The specific feature of the solution that we are envisaging is to have 3D modelling of the core, associating it with models that we have developed for both representing the state of the core in real time and in a precise manner, but also able to carry out predictive simulations of the future state of the nuclear reactor.

Hence, the main object of the invention is determining the state of stability of a core which coincides with the initial state—in other words the initial conditions—of the core of the nuclear reactor for which it is desired to simulate the path of the operating point from said initial (stable) state to a final state, the desired target.

### DISCLOSURE OF THE INVENTION

An object of the invention is to propose method for estimating future values of a physical quantity of a complex system.

The object is achieved in the context of the present invention through a method for estimating a future value of a physical quantity of an industrial system, the method comprising the following steps:
for each variable of a plurality of variables of the system, obtaining a sequence of successive measures of the variable, each variable being associated with a normalised variable defined as the ratio of the variable to a reference value, and normalising the sequence of successive measures so as to obtain a sequence of successive measures of the normalised variable,
determining a stability parameter of the system so as to obtain a sequence of successive values of the stability parameter, the stability parameter being a sum weighted by predetermined coefficients of the rate of variation of the normalised variables,
identifying a most recent stability time interval in which, for each point of the interval, the stability parameter is less than or equal to a predetermined threshold for a duration greater than or equal to a predetermined duration,
estimating, for a particular variable of the plurality of variables, a part of the sequence of successive measurements of the particular variable, so as to obtain a sequence of successive estimates of the particular variable, a start time of the sequence of successive measurements corresponding to an instant in the time interval, the estimation being carried out by an estimator,
comparing the sequence of successive estimates with the part of the sequence of successive measurements so as to determine a value of an adjustment parameter, the adjustment parameter being configured to be used by the estimator in order to improve the estimation, and
estimating the future value of the physical quantity of the system by the estimator based on the value of the adjustment parameter.

Such a method is advantageously and optionally supplemented by the various following features, taken alone or in combination:
a step of recording, over time, successive measures of the variables so as to obtain sequences of successive measures for each variable of the plurality of variables of the system;
the industrial system being a nuclear reactor, the plurality of physical variables comprises a power of the reactor, an average temperature of a reactor vessel, an axial power imbalance, a concentration of a chemical species in a heat-transfer fluid circulating in the reactor, the chemical species being configured to absorb neutrons in the reactor, and a position of a device configured to absorb neutrons in the reactor, the particular variable being the axial power imbalance;
estimating the future value of the physical quantity of the system takes into account a control scenario of the reactor corresponding to a sequence of successive values of at least one variable controllable by an operator;
a step of estimating future values of variables of the plurality of variables of the system and a step of determining a future value of the stability parameter based on future values of the variables of the plurality of variables of the system;
a step of determining a score of the control scenario, the score being a value of a quantity chosen from a volume of effluent produced, an average deviation from the reference axial imbalance and an average distance to the limits of an operating range of the reactor; and
the control scenario is a first control scenario, the estimate of the future value of the physical quantity of the system being carried out a second time by replacing the first scenario by a second control scenario of the reactor corresponding to another sequence of successive values of at least one controllable variable, the method preferably comprising a step of comparing scores of the first scenario and second scenario.

The invention also relates to a computer program comprising instructions suitable for implementing at least one of the steps of the method as presented above, when said program is executed on a computer.

Finally, the invention relates to a device for estimating a future value of a physical quantity of an industrial system, the device being configured to implement the method as presented above, the device comprising a processing unit configured:
for each variable of the plurality of variables of the system, to obtain the time series of measures of variables of the system, a sequence of successive measures of the variable, each variable being associated with a normalised variable defined as the ratio of the variable to a reference value, and to normalise the sequence of successive measures so as to obtain a sequence of successive measures of the normalised variable,
to determine the stability parameter of the system so as to obtain a sequence of successive values of the stability parameter, the stability parameter being a sum weighted by predetermined coefficients of the rate of variation of the normalised variables,
to identify the most recent stability time interval in which, for each point of the interval, the stability parameter is less than or equal to a predetermined threshold for a duration greater than or equal to a predetermined duration,
the device further comprising the estimator, configured to estimate, for a particular variable of the plurality of variables, a part of the sequence of successive measurements of the particular variable, so as to obtain a sequence of successive estimates of the particular variable, a start time of the sequence of successive measurements corresponding to an instant in the time interval,
the processing unit being configured to compare the sequence of successive estimates with the part of the sequence of successive measures so as to determine a value of an adjustment parameter, the adjustment parameter being configured to be used by the estimator in order to improve the estimate,
the estimator being configured to estimate the future value of the physical quantity based on the value of the adjustment parameter.

### DESCRIPTION OF THE FIGURES

Other features and advantages of the invention will emerge from the following description, which is given purely by way of illustration and not being limiting and which should be read with reference to the attached drawings, in which:

FIG. 1 is a schematic representation of a device for estimating a future value of a physical quantity of an industrial system according to an embodiment of the invention;

FIG. 2 is a schematic representation of axial imbalances DPAX over time.

FIG. 3 is a schematic representation of a power over time.

FIG. 4 is a schematic representation of a temperature over time.

FIG. 5 is a schematic representation of a boron concentration over time.

FIG. 6 is a schematic representation of an axial power imbalance over time.

FIGS. 7 and 8 are schematic representations of a position of neutron absorption devices, over time.

FIG. 9 is a schematic representation of a stability parameter over time.

FIG. 10 is a schematic representation of variables of the reactor over time.

### DETAILED DESCRIPTION OF THE INVENTION

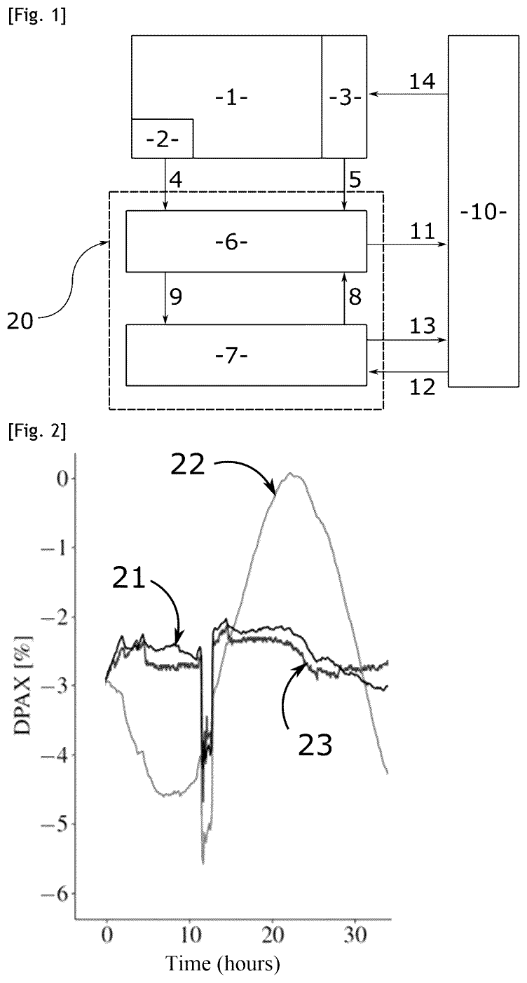

With reference to FIG. 1, a method and a device for estimating a future value of a physical quantity of an industrial system 1 are described.

In a first step of the method, a sequence of successive measurements of the variable are obtained for each variable of a plurality of variables of the system.

The variables used can be denoted Pⱼ with an index j varying from 1 to p.

The variables can be measured by sensors 2 of the system 1 so as to generate measurement sequences. The sensors 2 are connected via a connection 4 to a processing unit 6 of an estimation device 20. The connection 4 enables the measurement sequences to be transmitted to the processing unit 6.

The measurement can be the signal coming directly from the sensor or else a value deduced from one or more of these signals.

Some of the variables can be controlled via a control centre 3 of the system 1. The sequence of successive values of the control can then constitute in itself a sequence of measurements of the controlled variable. The control centre can be connected via a connection 5 to the processing unit 6, so as to transmit the sequences of controlled values to the processing unit 6.

The variables of the plurality of variables are chosen for their relevance with respect to the stability of the system 1.

A sequence of successive values taken by a quantity can also be designated by the expression “time series”. Such a sequence gives the evolution over time of the quantity. Each measurement of the sequence is time-stamped, in other words it is associated with a time of measurement or measuring time. It is therefore possible to draw a graph of the evolution of the quantity as a function of time based on the sequence of successive values. The time step which separates two successive values is preferably constant within a sequence. Two distinct variables can be measured, such that their time steps are equal or different.

During the first step, the processing unit 6 carries out a normalisation of each sequence of successive measurements.

Each variable is associated with a normalised variable defined as the ratio of the variable to a reference value, for example the value taken by the variable at a nominal operating point of the system. The reference value is predefined before implementing the method. During the normalisation for each variable, a sequence of successive measurements of the normalised variable is produced.

During a second step, the processing unit 6 determines a stability parameter of the system so as to obtain a sequence of successive values of the stability parameter.

The stability parameter is a sum weighted by predetermined coefficients of the rate of variation of the normalised variables.

The stability parameter, which can also be designated by the expression “Composite Stability Criterion” (abbreviated by CSC), can be written in the following form:

$$\\ C S C = {\sum }_{j = 1}^{p} {α}_{j} Δ {P}_{j} / Δ t$$

The parameter CSC appears here as the sum of p rates of variation ΔPⱼ/Δt each rate being weighted by a coefficient or relative weight αⱼ.

In other words, the stability parameter can be obtained by multiplying each measure of a rate of variation ΔPⱼ/Δt of a normalised variable Pⱼ by the predetermined coefficient αⱼ.

The variables Pⱼ are normalised and the coefficients αⱼ are dimensionless, such that the CSC is homogeneous inversely with time. The CSC can be expressed as “dP” homogeneous inversely with time. The unit called “dP” has been named “de Penguern” in homage to Lionel de Penguern, an EDF physicist, a part of whose work concerned the stability of nuclear reactors. The orders of magnitude mean that the CSC is often expressed in milli dP, i.e. 10⁻³ dP or mdP.

The variable Pⱼ varies by the quantity ΔPⱼ during the time interval Δt. These variations are deduced from the sequence of successive measurements of the variable Pⱼ.

The rate of variation of two different variables is not necessarily determined over the same time interval. This can be the case, in particular, if the two variables are not measured with the same time step. But this can also be the case if a characteristic variation time of the first variable is very different from a characteristic variation time of the second variable.

It can be imposed that the sum of the coefficients is equal to 1:

$$\\ {\sum }_{j = 1}^{p} {α}_{j} = 1$$

The coefficients are predetermined from data histories over a preliminary data analysis phase. More precisely, there is a historic database of operation of industrial systems for which the behaviour is sufficiently close to the system that it is desired to simulate. The database comprises, in particular, time-stamped records of measurements of variables Pⱼ from these other industrial systems. Within this database, ranges of stable operation and ranges of unstable operation can be defined for each industrial system. Coefficients αⱼ are then sought verifying that Σⱼ₌₁^{p} αⱼ=1 and a threshold “s” such that:

$$\\ C S C = {\sum }_{j = 1}^{p} {α}_{j} Δ {P}_{j} / Δ t \leq s$$

for all the stable operating ranges; and

$$\\ C S C = {\sum }_{j = 1}^{p} {α}_{j} Δ {P}_{j} / Δ t > s$$

for all the unstable operating ranges.

At the end of the preliminary data analysis phase, there is therefore a threshold s-referred to hereinafter as the “predetermined threshold”—and coefficients αⱼ which are the predetermined coefficients.

During a third step, the processing unit 6 determines a most recent stability time interval in which, for each point of the interval, the stability parameter is less than or equal to a predetermined threshold for a duration greater than or equal to a predetermined duration.

At the end of the second step, a sequence of successive values of the stability parameter is available. These values are compared with the predetermined threshold s. First time ranges are defined, on the basis of the sequence of successive values of the stability parameter, where CSC≤s and second time ranges where CSC>s.

For each instant of the first time ranges where CSC≤s, the duration is determined from which the inequality CSC≤s is checked and this duration is compared with a predetermined duration.

This makes it possible to identify, within the first time ranges where CSC≤s, the stability time intervals in which, for each point of the interval, the stability parameter is less than or equal to a predetermined threshold for a duration greater than or equal to the predetermined duration.

The most recent among these stability time intervals is then identified.

The predetermined duration can be established from data histories during a preliminary data analysis phase. The predetermined duration can, in particular, be given by a fraction of a characteristic time of an instability phenomenon which affects the industrial system, such as for example the largest or the slowest instability phenomenon.

During a fourth step, an estimator 7 of the estimation device 20 is used to carry out an estimate for a particular variable of the plurality of variables of a part of the sequence of successive measurements of the particular variable, so as to obtain a sequence of successive estimates of the particular variable.

The particular variable can be chosen as the most relevant variable among the plurality of variables with respect to the stability of the system 1. The estimator 7 can optionally produce an estimate of all of the variables of the plurality of variables.

Here, the estimator estimates a history of the system 1, in other words the evolution of the system 1 over a time range which has already taken place, since measurements of the system 1 for this time range are available. The estimator 7 supplies a sequence of successive estimates of the particular variable that can thus be compared with the measurements of this particular variable.

The time range which is the subject of this estimate corresponds to the most recent stability time interval, and more precisely a start time of the estimated sequence of successive measurements is a time included in the most recent stability time interval.

Hence, only a portion of the part of the sequence of successive measurements of the particular variable is estimated by the estimator 7.

This situation assumes a communication channel 9 from the processing unit 6 to the estimator 7. Data necessary for the estimate, such as, in particular, the most recent stability time interval, are transmitted from the processing unit 6 to the estimator 7.

The estimator 7 is a simulation tool of the system 1 which can supply predictions that are as close as possible to reality. However, such an estimator 7 necessarily has limits. For example, it cannot take into account the control history, which is not necessarily known to the developer of the simulation code. Furthermore, the estimator 7 also has limits because certain phenomena which are produced in the system 1 are not taken into account in the simulation code. This is the case for the phenomena which are not modelled, either because they are too complex or too heavy in terms of calculation (the code must be sufficiently quick in order to have industrial applications), or because they are linked to the imperfection in the experimental measurements (bias, noise, uncertainties).

During a fifth step, the processing unit 6 carries out a comparison of the sequence of successive estimates produced by the estimator 7 and the portion of the sequence of successive measurements.

This situation assumes a communication channel 8 from the estimator 7 to the processing unit 6. Data necessary for the comparison, such as, in particular, the sequence of successive estimates, are transmitted from the estimator 7 to the processing unit 6.

The processing unit 6 determines the variation between the estimate carried out and the recorded measurements of the particular variable. The processing unit 6 is configured to determine, on the basis of this comparison and for example from the variation, a value of an adjustment parameter. The adjustment parameter is configured to be used by the estimator 7 in order to improve the estimate already carried out and, more generally, estimates carried out for the corresponding period of time.

The comparison carried out by the processing unit 6 gives information with respect to the simulation limits of the estimator 7, and, in particular, the information not taken into account by the estimator 7, such as the history of the control or the phenomena that are not modelled.

The adjustment parameter can be of a different type, but it concerns a parameter used by the estimator 7 in order to produce its estimates and thus the value can be adjusted.

During a sixth step, the estimator 7 produces the estimate of the future value of the physical quantity of the system using the value of the adjustment parameter.

For this purpose, the adjustment parameter is transmitted from the processing unit 6 to the estimator 7. The value of the adjustment parameter is readjusted in the code of the estimator 7. In this way, the estimates produced by the estimator 7 are improved, because the information not taken into account by the estimator 7, such as the control history or the unmodelled phenomena are taken into account, at least partially, via the adjustment parameter.

The method is based on the use of a stability parameter which makes it possible to identify the most recent time range of stable operation of the system. Relative to this stability range, the precision of an estimate produced by the estimator is evaluated by comparing with a genuine measurement. On this basis, an adjustment parameter is determined which makes it possible, once transmitted to the estimator, to correct the estimates that the estimator can subsequently produce. The estimates produced of a future value of a quantity of the system can be improved, in particular, if the future value corresponds to a period of instability of the system.

This makes it possible to better predict the evolution of a complex industrial system, and, in particular, that of a nuclear reactor.

Optionally, the method comprises a step of recording, over time, successive measurements of the variables so as to obtain sequences of measurements. This step is prior to or simultaneous with the first step mentioned above.

We are presently concerned with the situation where the industrial system is a nuclear reactor.

A nuclear reactor is the seat of a fission chain reaction, mainly of uranium 235 nuclei, by neutrons. The neutrons emitted during a fission being too energetic to produce other fissions, it is necessary to slow them down in order to reach lower energy levels, where the probability of producing fissions is higher. It is the water circulating in the nuclear core which slows down the neutrons (acting as a moderator) and also transports the heat produced during fissions (acting as a heat-transfer fluid).

An absorber is a compound, voluntarily introduced or produced by the reactions in the core, which captures the neutrons preventing them from producing fissions.

It can involve:
boron (introduced in diluted manner into the moderator, in order to limit the chain reaction); the operator can act on the boron concentration in the moderator;
absorber rods: this is a device introduced into the assemblies in order to absorb neutrons and reduce the chain reaction; the operator can act on the absorber rods; for example, on the 1300 MWe stage, a group R, for controlling, is intended to control the temperature of the core, and a power compensator group (PCG), itself composed of several subgroups of different absorption rods, enables the power produced in the core to be modulated;
xenon 135: very efficient absorber of neutrons produced during operation of the core; the power variations of the reactor implement a complex physics which causes spatial and temporal oscillations in xenon concentration; the operator cannot act directly on the xenon, but must implement the means for controlling it when he controls the reactor;
samarium 149: also a neutron absorber, but less efficient than xenon: samarium is accumulated, unlike the xenon which decays with a period of approximately 9 hours;
various fission products generated during the operation of the core of less significant effect than xenon or samarium; the operator cannot act on these elements.

The chain reaction can therefore be controlled using rods, or clusters, of absorbers and boron. The control of these parameters makes it possible to establish the desired conditions in the core in order to produce the desired power.

However, the actions carried out by the operator must never lead, even temporarily, to passage through a state which could cause the integrity of the core to be lost. For this purpose, an operating range has been predefined. This range is established in consultation with the safety authorities of the country.

An operating domain is formed of a set of operating points, these points representing physical quantities associated with the normal operation of the reactor. The objective of a nuclear reactor operator is to maintain the state of the nuclear unit so that all the predefined operating points remain in said operating range.

This makes it possible, by monitoring the axial power imbalance (quantities AO, DI or DPAX mentioned above), to guarantee compliance of the integrity of the fuel.

When a power transient (in other words a request to modulate the produced power) is requested by the electricity grid, the nuclear unit concerned can manoeuvre so as to satisfy the request, or refuse to do so for safety reasons if its state does not enable compliance with the safety criteria.

The method makes it possible to simulate the power transient to be produced, on the basis of the current state of the reactor, in order to see whether the safety criteria are complied with. This is so as not to wrongly refuse to manoeuvre when the conditions permit it. The method also makes it possible to refine the control strategy in order to optimise the phase operating with knowledge.

In the case where the industrial system is a nuclear reactor, and with respect to the first step, the plurality of physical variables may comprise, in particular, the following variables:
a power of the reactor,
an average temperature of a reactor vessel,
an axial power imbalance DPAX as already previously introduced.

A fourth variable is a concentration of a chemical species in the heat-transfer fluid, the chemical species being configured to absorb neutrons in the reactor. For example, this chemical species is boron.

A fifth variable is a position of a device configured to absorb neutrons in the reactor. More precisely, it involves the axial position of this device which can be maintained above the zone where the neutrons circulate, or even descend into this zone. The lower the device is positioned in the structure, the more neutrons it captures. This makes it possible to modulate the power and the temperature of the reactor.

Such a device can be divided into different units which can be activated, in other words lowered into the zone where the neutrons circulate, independently of one another.

A first unit can be a group of rods forming a power compensation group (which can be designated by the abbreviation PCG). The PCG aims to compensate the power defect, in other words the anti-reactivity due to the power variation. The PCG can itself be composed of a plurality of subunits of different absorber rods. The PCG consists of multiple absorber rods which are inserted in the core. They are not all introduced into the core at the same time, so as to maintain the progressive nature of the absorbent action. They are distributed into several subgroups (G1, G2, N1 and N2) which each have several clusters of absorber rods, which have different levels of absorption, and which are distributed homogeneously in the core so as not to radially imbalance the neutron flux.

A second unit can be a control group (that can be designated by the abbreviation R group) of absorber rods. The R group is a group intended to control the temperature of the core.

More generally, in the case where the industrial system is a nuclear reactor, the plurality of variables could also comprise the following variables: the average temperature of the core of the reactor, the temperature of the hot branch, the temperature of the cold branch, the density of the water in the core, the effective temperature of the fuel and the associated Doppler effect, the temperature of the water in the core and the associated vacuum effect, the distribution of boron in the core, the distribution of xenon 135 in the core, the distribution of samarium 149 in the core, mechanical measurements, an azimuthal power imbalance along the radial dimension of the core (also known by the expression “tilt”).

The Doppler effect, mentioned above, corresponds to a counter reaction linked to the increase in temperature in the nuclear reactors. In a nuclear reactor, this is in particular uranium 238 which is the main seat of this effect. Indeed, the effective cross-section for neutron absorption of uranium 238 varies greatly in the epithermal range of the neutron energy spectrum, the seat of many resonances the amplitude of which varies with the temperature of the fuel. When the temperature of the fuel increases, the resonances broaden and thus the capture of neutrons which are not generating fissions increases immediately, leading to a drop in the neutron flux and therefore to a reduction in the number of fissions, which leads to a reduction in the power produced. The Doppler effect is one of the self-stabilising effects in the case of a power transient, and therefore temperature transient (like the moderator effect, see below) of the PWR. This is a beneficial effect which is sought for the intrinsic safety of nuclear reactors. This effect has fast temporal kinetics; it is one of the effects which acts first when a power transient appears.

The vacuum coefficient, mentioned above, characterises the evolution in the reactivity of the reactor in the event of reduction in the density of the heat-transfer fluid, which in this case is water. In the context of reactor physics, the reactivity measures the tendency of the reactor to increase its power (supercritical state), reduce its power (subcritical state), or to maintain a stable state (critical state). The vacuum coefficient enters into the composition of the reactivity of a nuclear reactor core. Pressurised water reactors are designed such that the water is both heat-transfer fluid and neutron moderator (in other words slows down neutrons) giving the reactors a negative vacuum coefficient, which is sought. Indeed, a negative vacuum coefficient corresponds to a self-stabilising effect of the nuclear reaction: if the neutron power increases, the density of the water drops, which has the effect of reducing the density of the moderator (the water is both heat-transfer fluid and moderator), thus reducing the probability of neutron impact by diffusion reaction on a water molecule, hence a reduced neutron deceleration, and thus a reduction in the number of fissions and consequently in the power.

The use of five variables, average temperature of a reactor vessel, axial imbalance of power DPAX, concentration in the heat-transfer fluid of a chemical species configured to absorb neutrons in the reactor and the position of a device configured to absorb neutrons in the reactor, enables the stability of the reactor in general to be described. The use of other variables mentioned above, in addition or in replacement of the five variables, enables the stability of other elements of the reactor to be described, for example the active core of the reactor, the steam generator, the primary circuit or the secondary circuit, etc.

In the example of the active core, the quantities of interest to stabilising are the three-dimensional fields of common parameters of neutron counter reactions, namely the physical quantities which act on the effective microscopic cross-sections of the physical calculation of the reactors (among others, the calculation of the three-dimensional power in the core). It will be recalled that the effective cross-section is a quantity for which the unit is the barn (10⁻²⁴ cm²) measuring the capacity or reaction rate of a nucleus (microscopic cross-section) or of a set of nuclei (microscopic cross-section; product of the microscopic cross-section and the density of nuclei of the same element considered) to come into interaction with a neutron, said interactions are absorption, fission and diffusion. For a given interaction, the greater the effect of the nuclear cross-section, the greater is said reaction rate with a neutron. The parameters in question are the following three-dimensional fields: the density of the water in the core, the effect of temperature of the fuel, the temperature of the water in the core, the distribution of boron in the core, the distribution of xenon 135 in the core and the distribution of samarium 149 in the core. These quantities are normalised with respect to a typical order of magnitude such that a homogeneous reference increment of the 3D field produces a typical value of the CSC (for example 30 millidP of stability on the axial offset). The relevant weights for weighting the analysis of the reactor cores operational database enable a composite criterion to be calculated in the same way as the CSC, previously described in connection with the stability of the reactor in general and the five variables.

The use of the stability parameter in connection with the active core makes it possible, in a non-exhaustive manner:
to indicate, in a highly visual manner, to the operator that the observed component is “stable”; the core is, in particular, stable when the operator changes nothing and the characteristic quantities keep the same value for several hours, or even several days; in other words when there is no transient in progress and, in particular, no power transient or xenon oscillation;
to use the numerical values of the stability parameter in order to accelerate the calculations, for example by increasing the time step of the core code based on stability criteria; to avoid recalculating the effective cross-sections, a very significant calculation item in the entire core calculation; to avoid printing that is unnecessary, or even costly in terms of calculation time, based on stability criteria;
to contribute to the elaboration of a stability parameter corresponding to the entire nuclear unit; and indicate which component is unstable in a multi-component assembly, etc.

In the case where the industrial system is a nuclear reactor, and with respect to the second step, the stability parameter or Composite Stability Criterion is then written in the form of a sum of five rates of variation of the five variables.

In the case where the industrial system is a nuclear reactor, and with respect to the third step, the predetermined duration which takes part in the application of the method can be given on the basis of the xenon oscillation instability phenomenon. The characteristic oscillation time being between 15 and 35 hours, it is possible to choose a predetermined duration between 3 and 15 hours.

In the case where the industrial system is a nuclear reactor, and with respect to the fourth step, the estimator 7 comprises a neutron calculation code in order to simulate the behaviour of the nuclear core.

This code incorporates implementations of nuclear physics equations and numerical solvers to solve them. The code uses a 3D modelling of the reactor in order to perform the calculations.

This 3D aspect can equally well correspond to an explicit modelling in three-dimensions of the core in the calculation code, as is the case in the method presented here, as well as to modelling in two dimensions (as a general rule, a core is reduced to a radial plane) followed by a deployment of the results in the axial direction (there is therefore a 2D×1D approach).

The physical parameters introduced are calculated by the neutron calculation code which is, more precisely, a code for nuclear reactor physics, the main principles of which are now disclosed.

The 3D physical code for nuclear reactors is understood here as a software configured to calculate the three-dimensional distribution of power (in Watts) in a nuclear reactor core on the basis of structural data (geometry, chemical composition, composition of heavy nuclei, etc.).

In order to do this, the software must be able, for example, in three-dimensional geometry, to calculate the distribution of temperatures of the heat-transfer fluid in the core of the reactor. The heat-transfer fluid is the fluid which removes the heat produced by the nuclear fissions. This calculation can, in particular, be carried out by a code module called the “thermohydraulic module”.

The software must also be able to calculate the temperature distribution of the nuclear fuel. This calculation can, in particular, be carried out by a module called the “thermodynamic module” or “thermomechanical module” if mechanical aspects are also treated (for example the pellet-sleeve interaction).

The software must also be able to calculate the neutron flux distribution from which the power derives. This calculation can, in particular, be carried out by a module called the “neutronics module”.

It is the coupled interaction of these three modules above which enables the 3D power in the core of the reactor to be calculated.

The neutronics modifies the temperatures of the heat-transfer fluid, and the temperature of the heat-transfer fluid modifies the temperatures of the fuel. The temperatures of the moderator and of the fuel modify the neutronics. Indeed, a fission (nuclear physics) is caused by an interaction of a heavy nucleus with neutrons (managed by the the neutronics module), said fission producing heat which propagates into the matter (managed by the thermodynamics module), which transmits its heat to the water, the heat-transfer fluid, which transports it by raising its temperature (managed by the thermohydraulics module) and consequently modifies the temperature of the fuel.

Thus counter-reaction phenomena are observed. The water heat-transfer fluid also being the moderator by which the neutrons are slowed down in order to promote fissions, its temperature variation will modify the density and therefore the slowing down of neutrons which thus impacts the future generation of fissions. At the same time, a temperature modification of the fuel increases the neutron absorption reactions, in particular, in Uranium 238, which modifies the neutronics.

Hence, the above-mentioned physical phenomena which are produced within a nuclear reactor have a high complexity, which requires the use of codes for physical calculations of cores. For example, it is possible to use a calculation code which comprises:
a 1D axial thermohydraulics module in the channel containing the water heat-transfer fluid,
a 1D radial thermodynamics module in the cylindrical fuel rod, and
a theoretical 3D neutronics module of the neutron diffusion.

The neutron diffusion is a theoretical model used to process a simplified form of the Boltzmann equation which governs the behaviour of neutrons in matter. Descriptions of theoretical models are found in the French language reference “La physique des réacteurs nucléaires, 3rd edition” (author Serge Marguet, ISBN 978-2-7430-1105-5, published by Lavoisier) and in the English language reference “The physics of nuclear reactors” (author Serge Marguet, ISBN 978-3-319-59558-7, published by Springer). Other older reference works describe the fundamental principles of the physics of nuclear reactors, such as “Traité de Neutronique” by Jean Bussac and Paul Reuss, published by HERMANN ISBN 2-705-6011-9-second edition, 1985.

In order to obtain satisfactory estimates of variables, it can be useful to carry out several iterations in order to evaluate the assembly at equilibrium. Once convergence is obtained, the physical code of the reactors can produce the results necessary for the operation and safety of the reactor, providing considerable assistance in the control of a nuclear reactor core and, in particular, for the location and values of hotspots, an “intelligent” power distribution, calculated responses of the various instrumentations of the core, control and stability of the reactor as a function of time, irradiation of the nuclear fuels (evaluation of burn-up), and the three-dimensional distribution of xenon 135.

In the case where the industrial system is a nuclear reactor, and with respect to the fourth step, the particular variable that is chosen to implement the method is the axial power imbalance, which is particularly relevant for estimating the stability of the reactor.

In the case where the industrial system is a nuclear reactor, and with respect to the fifth step, the adjustment parameter can be chosen as a parameter δ₀ involved in the definition of fast neutron diffusion coefficients within the reactor at the upper limit and at the lower limit along the vertical axis z of the reactor. The fast neutrons correspond to the most energetic population of neutrons generated in the reactor.

With respect to these coefficients, the diffusion coefficient is defined at the upper limit of the reactor D_{1,sup ref} provided by the estimator during the first estimation, the diffusion coefficient at the lower limit of the reactor D_{1,inf ref} provided by the estimator during the first estimation, diffusion coefficients at the upper and lower limit of the reactor D_{1,sup} D_{1,inf} corrected by using the adjustment parameter δ₀.

The correction is based on the following relations:

$$\\ {D}_{1 , sup} = ( 2 - {δ}_{0} - {β}_{p} ( P - {P}_{nom} ) ) {D}_{1 , sup ref}$$

$$\\ {D}_{1 , inf} = ( {δ}_{0} + {β}_{p} ( P - {P}_{nom} ) ) {D}_{1 , inf ref}$$

P designates the power of the reactor and Pₙₒₘ the nominal power of the reactor, the parameter βₚ is a predetermined correction coefficient which does not depend on the power P.

By comparing the estimate of the estimated axial imbalance and the measured axial imbalance, the value of the parameter 80 can be found which makes it possible, by correcting the diffusion coefficients according to the preceding relations, to recalibrate the estimator. The estimator thus pre-calibrated then provides estimates of the axial imbalance which correspond better to the measurements.

The reflection of neutrons at the upper limit and at the lower limit are part of the modelling limits of neutron diffusion in the reactor.

The error committed is all the greater, the greater the nominal power of the reactor. The part of the error committed in the estimations which come from this deviation from the nominal power is taken into account by the term βₚ(P-Pₙₒₘ) which is cancelled when the deviation at the nominal power is zero.

The remainder of the error committed is taken into account by the term δ₀, which term is more related to the control history that is not taken into account elsewhere in the modelling.

FIG. 2 shows the effect of the method on the precision of the estimates provided. FIG. 2 shows three curves 21, 22 and 23 of the axial imbalance DPAX over time. Curve 21 shows a measured axial imbalance DPAX. Curves 22 and 23 show an estimated axial imbalance DPAX carried out by the estimator at t=0.

For curve 22, the estimation has been carried out by the estimator using the value of an adjustment parameter estimated by comparing a sequence of estimates and successive measurements of the axial imbalance with a start time of the sequence of successive measurements corresponding to an instant which is not included in a stability time interval.

For curve 23, the estimation corresponds to the method described above. It has been carried out by the estimator using the value of an adjustment parameter estimated by comparing a sequence of estimates and successive measurements of the axial imbalance with a start time of the sequence of successive measurements corresponding to an instant which is included in a stability time interval, namely the most recent stability time interval.

Estimation curve 23 is significantly closer to measurement curve 21 than estimation curve 21. In practice, curve 23 provides a sufficiently precise estimate to enable the operator to calmly understand the actions to take, when curve 21 does not provide sufficient precision.

The use of the adjustment parameter determined on the basis of the most recent stability time interval thus provides a better precision in the estimate. This is referred to as a ‘green’ adjustment parameter.

The application of the method to the case of the nuclear reactor enables:
a better response rate to the network requests (greater precision in the calculations making it possible to not exclude power transients to be produced due to the uncertainty in the compliance with safety margins),
better optimisation of the control strategies (greater precision in the calculation makes it possible to anticipate future situations more finely, and to draw up, with more relevance, the optimum strategy for better responding to the economic and environmental demands), and
economic gains linked to attaining stability of the core earlier, when this is necessary (tests).

The general energy context leads to increased demand for manoeuvrability of nuclear units. More specifically, the installed capacities of renewable energies are increasing. These being by nature intermittent, nuclear units will be increasingly requested to modulate their production.

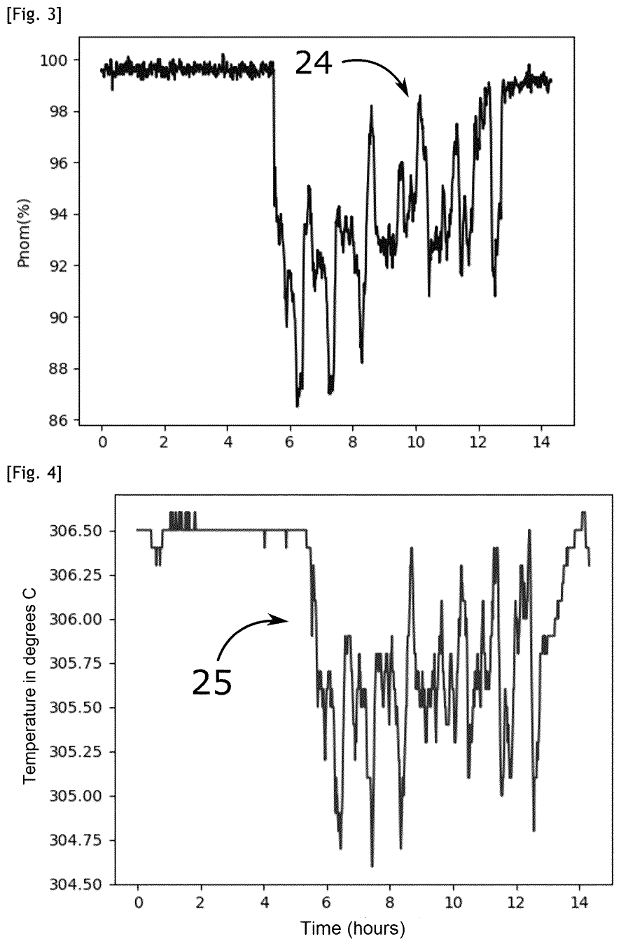

FIGS. 3 to 9 show a calculation of the stability parameter for a time range of approximately 15 hours. Each of the figures represents variations of one variable over this time range, the time being indicated by the abscissa on an axis graduated in hours.

FIG. 3 shows a normalised power curve 24, the vertical axis is graduated in percentage of nominal power.

FIG. 4 shows a temperature curve 25, the vertical axis is graduated in degrees Celsius.

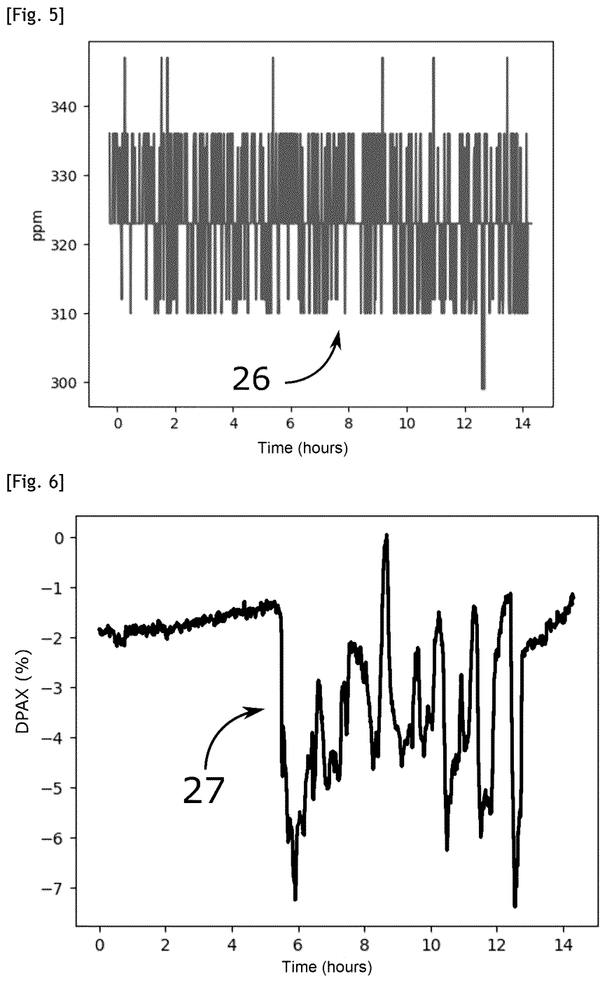

FIG. 5 shows a boron concentration curve 26, the vertical axis is graduated in ppm.

FIG. 6 shows a curve 27 of axial power imbalance, the vertical axis is graduated in percentage (the DPAX is calculated as a ratio of powers, thus without units. It is expressed in percentage).

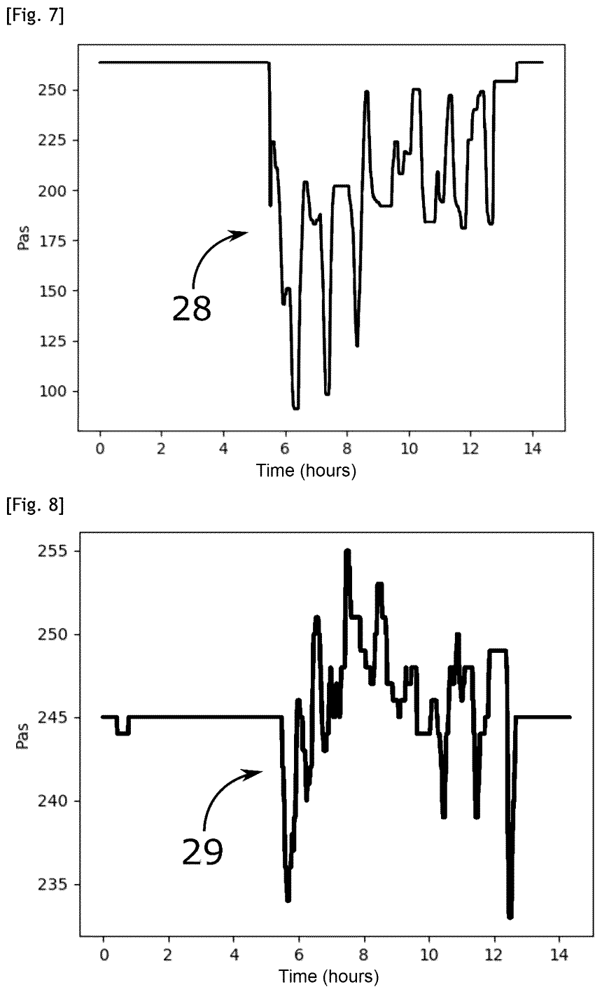

FIG. 7 shows a curve 28 of position of a first device, which is a first unit “G1” of the PCG neutron absorption group, the vertical axis is graduated in steps which correspond to a length: one step is 1.5 centimetres. The insertion and extraction of rods are implemented discreetly such that the rods can only take a series of discrete axial positions. Each insertion (or respectively extraction) of a rod is made by moving downwards (or respectively upwards) by a fixed length of order 1.5 cm, this defines a step.

FIG. 8 shows a curve 29 of the position of a second neutron absorption device, the control group R, the vertical axis is graduated in steps. Here the step is defined in the same way as before.

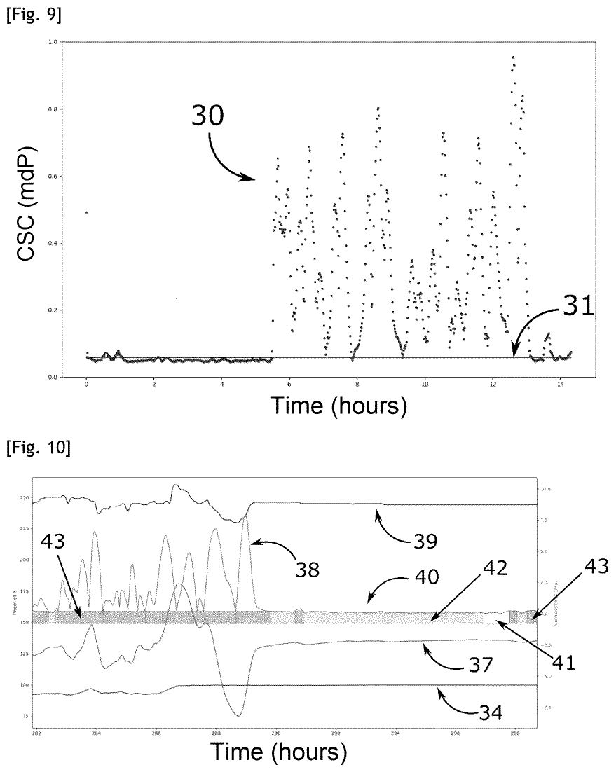

FIG. 9 shows a point cloud 30 representing the stability parameter as a function of time. The stability parameter is determined from the preceding variables; the vertical axis is graduated in dP. The straight line 31 shows the predetermined threshold which is equal here to 30 mdP.

FIG. 9 shows a high volatility in the numerical value of the stability parameter when actions are carried out by the operator (for example, the movements of absorber clusters after 6 hours on the preceding curves). This was intended in the design of the stability parameter. Conversely, passing below a given threshold, for a given chosen duration, enables the stability of the reactor to be guaranteed.

In the case presented in these figures, there is no stability time interval, in other words no time phase where the stability parameter remains below the predetermined threshold for longer than the predetermined duration. In other words, there is no stability sufficient for determination of the adjustment parameter. If it is desired to implement the method, the adjustment parameter to be used for an estimation must therefore come from a preceding stability phase. If there has not yet been a stability phase, for example in the case of commissioning of the core, it is possible to use a default parameter which is equivalent to an absence of adjustment, which enables correct predictivity. More specifically, the main objective of the adjustment model is to compensate for historic effects which are, in fact, limited when the reactor has been operating for a short time. “Compulsory” stability phases are required for the performance of periodic tests. The adjustment parameters will then have a minimum of adequate ranges to be determined.

The stability parameter can be supplied to the operator in order to signal to him the current stability level of the reactor or past stability levels. With regard to FIG. 1, a device for human machine interaction 10 can display the stability parameter calculated by the processing unit 6. A connection 11 between the human machine interaction device 10 and the processing unit 6 enables this information to be transferred.

FIG. 10 illustrates a calculation of the stability parameter for a time range of approximately 16 hours. The time is indicated on the abscissa on an axis graduated in hours. Curve 34 shows the power, curve 37 the axial power imbalance, curve 38 the position of a first neutron absorption device, and curve 39 the position of a second neutron absorption device, the control group R. Finally, the strip 40 shows the stability parameter. The level of grey of the strip 40 is determined in the following way:
grey level 41 corresponds to the stability time intervals, where the stability parameter is less than the threshold for a duration greater than or equal to the predetermined duration; grey level 41 corresponds to a stable state of the reactor;
grey level 42 corresponds to the intervals where the stability parameter is less than the threshold but for a duration less than the predetermined duration; grey level 42 corresponds to state of the reactor in the course of stabilisation; and
grey level 43 corresponds to the intervals where the stability parameter is greater than the threshold; grey level 43 corresponds to an unstable state of the reactor.

Such a display of the stability parameter on the human machine interaction 10 enables the operator, according to the grey level or according to the colour code with green (stable)/orange (in the course of stabilisation)/red (unstable) to appreciate immediately the state of the unit. This can be an assistance, for example, when starting certain tests requiring a sufficiently stable starting point.

In this example, a manoeuvre of the reactor is carried out in a first portion on the left of the curve corresponding to a safety parameter, most often indicating an unstable state of the reactor (zones with grey level 42). The second portion, once the manoeuvre is achieved, allows a state to be visualised during stabilisation of the reactor (grey zones level 42) then a stable state of the reactor. This visualisation enables the operator to ensure starting of an envisaged test or a new manoeuvre when the reactor is in a stable state.

The estimate of the future value of the physical quantity of the system can also take into account a control scenario of the reactor corresponding to a sequence of at least one variable controllable by an operator.

A controllable variable can be a power setpoint, the position of a device configured to absorb neutrons in the reactor, a flow rate of the heat-transfer fluid or even the concentration of a chemical species in the heat-transfer fluid. A power setpoint or a load program is an evolution of the electrical power of the reactor as a function of time. This evolution can, in particular, be given in the form of a sequence of successive values of a power to be observed, in other words power setpoint values, as a function of time. Here, therefore, a power setpoint is therefore understood to mean a physical quantity homogeneous with a power and which is the power to be observed.

The operator can define a control scenario, in other words the various actions that it is envisaged to carry out. These relate to the controllable variables such as, for example, the positions of the control rods or the boron concentration. The operator chooses, for at least one controllable variable, a sequence of successive values which the variable takes during the next hours.

The operator then enters the data characterising the scenario as input to the estimator 7 via a connection 12 between the estimator 7 and the human-machine interface device, as illustrated in FIG. 1.

For example, the operator can rely on a first estimate of the evolution of the axial power imbalance, without a scenario being specified and on the basis of this simulation, determines a scenario and relaunches a second estimate of the evolution of the axial power imbalance which this time takes into account the determined scenario. The first and second estimates are transmitted via a connection 13 from the estimator 7 to the human-machine interface device 10, as illustrated in FIG. 1.

The method, as it has been presented, can also comprise a step of estimating future values of variables of the plurality of variables of the system and a step of determining a future value of the stability parameter from future values of the variables of the plurality of variables of the system.

For this purpose, it is each variable of the plurality of variables which is the physical quantity for which the method estimates a future value.

A first advantage of the method thus modified is to identify possible futures ranges of stability of the reactor. When the estimated stability parameter is less than or equal to the predetermined threshold for the predetermined duration, a stability time interval commences. It lasts as long as the estimated stability parameter remains less than or equal to the predetermined threshold.

The second advantage of this method is to solve the problem of the first value of the estimates which is different from the corresponding measurement.

As previously stated, when the time t=0, corresponding to the time when the estimate is produced, is not part of a stability time interval, there is a risk that the first values of the estimates are significantly different from the first measurements. In order to guarantee that the first values of the estimates are substantially identical to the first measurements, the method can be modified in the following manner.

The adjustment parameter for estimating the first value is the local adjustment parameter, in other words associated with the estimation time t=0. The local adjustment parameter is determined by comparing a sequence of estimations and successive measurements of the axial imbalance with a start time of the sequence of successive measurements corresponding to a time just preceding time t=0.

In order to estimate the following values, the local adjustment parameter is kept as the estimated stability parameter and remains significantly constant. The stability parameter used for this purpose is estimated from estimated values of the variables of the plurality of variables.

If the stability parameter varies, then the local adjustment parameter is replaced by a mixed adjustment parameter which is calculated by taking into account the local adjustment parameter and the ‘green’ adjustment parameter. In other words, the local adjustment parameter is based on both a comparison of a sequence of estimates and successive measurements of the axial imbalance with a start time of the sequence of successive measurements corresponding to a time just preceding time t=0, and both on a comparison of a sequence of estimates and successive measurements of the axial imbalance with a start time of the sequence of successive measurements corresponding to an instant which is included in the most recent stability time interval.

Therefore, gradually, iterations are carried out in the estimate of a transition of the local adjustment parameter to the ‘green’ adjustment parameter when the stability parameter varies. More specifically, the local adjustment parameters, adjusted to a situation of the reactor having a certain level of instability, are no longer valid when this level of instability varies, and it is therefore necessary to recover the green adjustment parameters. This “level of instability” is of course accessible by calculating the CSC.

Through this modification, the method can ensure a prospective simulation:
the start of which is in agreement with the experimental measurements
the progress of which remains predictive through the ‘green’ adjustment parameters, ideally determined using the CSC.

The method can further comprise a step of determining a score of the control scenario. This score can be a value of a quantity chosen from a volume of effluent produced, an average deviation from the reference axial imbalance and an average distance to the limits of an operating range of the reactor.

The operators rely on this control diagram representing the axial imbalance as a function of the total instantaneous power. This diagram illustrates, in particular, a safety zone or operating domain of the reactor which is a zone around a reference straight line. The reference axial imbalance corresponds to this reference straight line. The reactor must operate in the zone close to the reference straight line.

The operating domain of the reactor and thus the limits of this domain are likewise defined with respect to the control diagram. This operating domain is a safety zone which is located around the reference straight line. It can, for example, be defined by axial imbalance limit straight lines in the diagram. The average distance to the limits can be evaluated as the distance to one of these straight lines of axial limit imbalances.

The score of the scenario can provide the operator with an evaluation of the scenario estimated with respect to effluent production criteria which will require a particular treatment or reactor stability criteria.

It is possible to implement an estimate of two scenarios that the operator then compares on the basis of their respective scores. In this case:
the control scenario previously mentioned is then a first control scenario,
a second scenario is obtained and transmitted as input of the method, this second scenario corresponds to a sequence of at least one variable controllable by an operator, a different sequence to that which corresponds to the first scenario, and
the step of estimating the future value of the physical quantity of the system being carried out a second time by replacing the first scenario by the second scenario.

Advantageously, the method comprises a step of comparing the scores of the first scenario and the second scenario.

It should be noted that the different curves corresponding to the different estimated scenarios can be displayed on the same graph in order to be able to be visually compared by the operator.

When the method comprises a step of comparing the scores of the first scenario and the second scenario, the method can further provide a classification of the scenarios in increasing order for the selected criteria or, if several criteria have been calculated, for each of these criteria.

With reference to FIG. 1, it is the device 20 for assisting with the decision which can provide this classification of the scenarios for which the estimations are carried out by the estimator 7.

Once the scenario is chosen by the operator, this can send the corresponding instructions to the control centre 3 of the system 1, for example via the connection 14 between the human-machine interface device 10 and the control centre 3, as illustrated in FIG. 1.

An object of the invention is a computer program comprising instructions suitable for implementing at least one of the steps of the method, as presented above, when said program is executed on a computer.

With regard to FIG. 1, an object of the invention is a device 20 for estimating a future value of a physical quantity of an industrial system 1, the device 20 being configured to implement the method, as presented above, the device 20 comprising a processing unit 6 configured:
for each variable of the plurality of variables of the system, to obtain the time series of measurements of variables of the system, a sequence of successive measurements of the variable, each variable being associated with a normalised variable defined as the ratio of the variable to a reference value, and to normalise the sequence of successive measurements so as to obtain a sequence of successive measurements of the normalised variable,
to determine the stability parameter of the system so as to obtain a sequence of successive values of the stability parameter, the stability parameter being a sum weighted by predetermined coefficients of the rate of variation of the normalised variables,
to identify the most recent stability time interval in which, for each point of the interval, the stability parameter is less than or equal to a predetermined threshold for a duration greater than or equal to a predetermined duration,
the device further comprising the estimator 7, configured to estimate, for a particular variable of the plurality of variables, a part of the sequence of successive measurements of the particular variable, so as to obtain a sequence of successive estimates of the particular variable, a start time of the sequence of successive measurements corresponding to an instant in the time interval,
the processing unit 6 being configured to compare the sequence of successive estimates and the part of the sequence of successive measurements so as to determine a value of an adjustment parameter, the adjustment parameter being configured to be used by the estimator in order to improve the estimate,
the estimator 7 being configured to estimate the future value of the physical quantity by using the value of the adjustment parameter.

1. A method for estimating a future value of a physical quantity of an industrial system, the method comprising the following steps implemented by an estimation device:
for each variable of a plurality of variables of the system, obtaining a sequence of successive measures of the variable, each measure being performed at a corresponding measuring time,
for each variable, defining a normalised variable as a ratio of the variable to a reference value, and determining a sequence of successive measures of the normalised variable, by calculating for each measure of the variable a measure of the normalised variable,
for each variable, determining a sequence of successive measures of a rate of variation of the normalised variable by calculating for each pair of following measures of the normalised variable a ratio of a difference between the following measures over a length of an interval of time between measuring times that correspond to the pair of following measures,
determining for each measuring time a measure of a stability parameter of the system by multiplying each measure of a rate of variation of a normalised variable by a predetermined coefficient, the measure of the rate of variation corresponding to the measuring time and adding results of the multiplication,
identifying a most recent stability time interval in which, for each measuring time comprised in the stability time interval, the stability parameter is less than or equal to a predetermined threshold for a duration greater than or equal to a predetermined duration,
estimating, for a particular variable of the plurality of variables, a part of the sequence of successive measurements of the particular variable, so as to obtain a sequence of successive estimates of the particular variable, a start time of the part of the sequence of successive measurements of the particular variable being comprised in the stability time interval, the estimating being carried out by an estimator of the estimation device,
comparing the sequence of successive estimates of the particular variable with the part of the sequence of successive measurements of the particular variable so as to determine a value of an adjustment parameter, and
estimating the future value of the physical quantity of the system by the estimator, based on the value of the adjustment parameter.

2. The method according to claim 1, further comprising a step of recording, over time, successive measures of the variables, so as to obtain the sequences of successive measures for each variable of the plurality of variables of the system.

3. The method according to claim 1, wherein, the industrial system is a nuclear reactor and the plurality of the variables comprises:
a power of the nuclear reactor,
an average temperature of a reactor vessel,
an axial power imbalance,
a concentration of a chemical species in a heat-transfer fluid, the heat transfer fluid circulating in the reactor, the chemical species being configured to absorb neutrons in the nuclear reactor, and
a position of a device, the device being configured to absorb neutrons in the nuclear reactor,
the particular variable being the axial power imbalance.

4. The method according to claim 3, wherein estimating the future value of the physical quantity takes into account a control scenario of the nuclear reactor, the control scenario corresponding to a sequence of successive values of at least one variable controllable by an operator.

5. The method according to claim 4, comprising a step of estimating future values of variables of the plurality of variables of the system, and a step of determining a future value of the stability parameter based on estimates of future values of the variables of the plurality of variables of the system.

6. The method according to claim 4 further comprising a step of determining a score of the control scenario, the score being a value of a quantity chosen from among a volume of effluent produced by the nuclear reactor, an average deviation from a reference axial imbalance and an average distance to the limits of an operating range of the nuclear reactor.

7. The method according to claim 4, wherein the control scenario is a first control scenario, the estimation of the future value of the physical quantity being carried out a second time by replacing the first scenario by a second control scenario of the nuclear reactor corresponding to another sequence of successive values of at least one controllable variable.

8. A computer program comprising instructions suitable for implementing at least one of the steps of the method according to claim 1 when the program is executed on a computer.

9. A device for estimating a future value of a physical quantity of an industrial system, the device comprising a processing unit configured:
for each variable of the plurality of variables of the system, to obtain a time series of measures of variables of the system and; a sequence of successive measures of the variable,
for each variable, to define a normalised variable as a ratio of the variable to a reference value and to determine a sequence of successive measures of the corresponding normalised variable by calculating for each measure of the variable a measure of the normalised variable,
for each variable, to determine a sequence of successive measures of a rate of variation of the normalised variable by calculating for each pair of following measures of the normalised variable a ratio of a difference between the following measures over a length of an interval of time between measuring times that correspond to the pair of following measures,
to determine for each measuring time a measure of a stability parameter of the system by multiplying each measure of a rate of variation of a normalised variable by a predetermined coefficient, the measure of the rate of variation corresponding to the measuring time and adding results of the multiplication,
to identify the most recent stability time interval in which, for each measuring time comprised in the stability time interval, the stability parameter is less than or equal to a predetermined threshold for a duration greater than or equal to a predetermined duration,
the device further comprising the estimator, configured to estimate, for a particular variable of the plurality of variables, a part of the sequence of successive measurements of the particular variable, so as to obtain a sequence of successive estimates of the particular variable, a start time of the part of the sequence of successive measurements of the particular variable being comprised in the stability time interval,
the processing unit being configured to compare the sequence of successive estimates of the particular variable and the part of the sequence of successive measurements of the particular variable, so as to determine a value of an adjustment parameter,
the estimator being configured to estimate the future value of the physical quantity based on the value of the adjustment parameter.

10. The method according to claim 7 comprising a step of comparing the score of the first scenario and the score of the second scenario.
